(19) United States
(12) Patent Application Publication
(10) Pub. No.: US 2005/0066291 A1
(43) Pub. Date: Mar. 24, 2005

(54) Manual user data entry method and system

(76) Inventor: Stanislaw Lewak, Del Mar, CA (US)

Correspondence Address: Martin J. Jaquez, Esq.;JAQUEZ & ASSOCIATES, Suite 100D, 6265 Greenwich Drive, San Diego, CA, 92122, US

(21) Appl. No.: 10/944,370

(22) Filed: Sep. 17, 2004

Related U.S. Application Data
(60) Provisional application No. 60/504,459, filed on Sep. 19, 2003.

(51) Int. Cl. G06F 3/00

(52) U.S. Cl. 715/810; 715/818; 715/828; 715/829; 715/841; 715/845

(57) ABSTRACT

A menu-based data input method and system that is particularly suitable for manual user data input to a computing device via a data entry device that may be integrated, for example, into a PDA. An initial menu is subsequently replaced by a subsequent menu upon effective initiation of a stroke in a selected region of the initial menu, and the stroke is indicated as continuing at a location within the subsequent menu that substantially corresponds to the location of the selected region with respect to the initial menu. Paths followed by the stroke are substantially irrelevant, except that if a stroke path traverses a modifier region within an intermediate menu then the intermediate menu is replaced by a further menu. Data items are indicated as corresponding to particular regions within a terminal menu, and the corresponding data item is entered into the computing device when a stroke is terminated within a particular region of the terminal menu.

### CROSS-REFERENCE TO RELATED PROVISIONAL APPLICATION—CLAIM OF PRIORITY TO PREVIOUSLY FILED PROVISIONAL APPLICATION

This application claims the benefit under 35 U.S.C. § 119 (e) of pending U.S. Provisional Application No. 60/504,459, filed Sep. 19, 2003, entitled “Manual User Data Entry Method and System”, hereby incorporated by reference herein in its entirety although set forth in full.

### BACKGROUND

1. Field of the Invention

This invention generally relates to methods and systems by which users manually enter data into a computing device, and particularly to a graphic display of specific data that may be selected by initiation and termination of a selection action.

2. Related Art

For general or desktop computing, a mouse and keyboard are probably the most common devices employed by users for manually entering data. However, for miniaturize computing devices, such as Personal Digital Assistants (PDAs) and enhanced cellular telephones, both of these data entry techniques are unwieldy. Consequently, a number of different systems and methods have been proposed that are particularly suited for entry on such miniaturized devices.

Each such existing system suffers from one difficulty or another. Some involve “character recognition,” and are subject to several drawbacks. First, a character that is entered may be misinterpreted, which is to say that there is some ambiguity in interpretation of the intended data. The wider the range of data that may be entered by such recognition methods, the larger is the likelihood of error. Second, characters selected for such entry are generally either selected from one or more preexisting sets of characters, or else involve new patterns or types of strokes. Selecting characters from existing character sets generally means that a relatively large number of strokes will be required to enter single characters. Moreover, the wide range of character styles in general use increases the likelihood of error in recognizing such entry. However, while selecting a substantially new character set may reduce the number of strokes required, and may even reduce the likelihood of mistaken entry, such new set generally imposes a substantial learning burden on a new user. Such an entry burden may effectively prevent such systems from gaining wide acceptance.

Other systems permit unambiguous data entry by requiring a user to select specific, predefined data. The technique that effects such selection should desirably be rapid and accurate, should permit access to a wide range of specific data, and desirably permits a skilled user to gradually apply less attention to the acts of entry. Data entry through a “querty” (or other) keyboard is an example that permits a relatively wide range of data entry that may be entered by a novice user (e.g. using a “hunt and peck” entry technique), which permits skilled users to enter data rapidly, and with very little attention to the data entry actions.

Unfortunately, each system that has been heretofore proposed for data entry has one or more flaws that impair its ability to achieve all of the goals of data entry methods, and thus to become the next widely-accepted standard for computer device data entry. The goals for such systems include 1) the capability of high efficiency for an expert user (i.e., enabling rapid, unambiguous entry of a wide range of data while requiring relatively low user attention); 2) ability for novice users to enter data intuitively (i.e., with a very low training period or short “learning curve”), accurately, and reasonably quickly; and 3) compatibility with the available features of miniaturized computing devices. Each present manual user data entry input system falls short in respect to one or more of these goals. The manual user data entry method and system set forth below provides a number of features which, taken together, satisfy all of these goals.

### SUMMARY

A menu-based data input method and system is disclosed that is particularly suitable for manual user data input to a computing device via a small entry device that may be integrated, for example, into a Personal Digital Assistant (PDA), Power PC, or any other computing device. The method and system finds application in any computing device where enhanced usability is desired. In accordance with one embodiment, an initial menu (also referred to herein as an “input menu” or “data selection menu”) may be subsequently replaced by one or more secondary data selection menus upon an effective initiation of an input stroke in a selected region of the initial input menu. The input stroke may be indicated as continuing at a location within the secondary menu that substantially corresponds to the location of the selected region with respect to the initial menu. In one embodiment, the initial data selection menu is subsequently replaced by a secondary terminal data selection menu upon effective initiation of an input stroke in a selected region of the initial menu. In other embodiments, the initial menu is subsequently replaced by one or more secondary data selection menus. The speed at which the subsequent data selection menus replace previous menus may be fixed, in one embodiment, or user-configurable in other embodiments.

Paths followed by the input stroke are substantially irrelevant, except that if an input stroke path traverses a modifier region within an intermediate data selection menu, then the intermediate data selection menu is replaced by a further subsequent data selection menu corresponding to such modifier region. Data items are indicated as corresponding to particular regions within a terminal data selection menu, and the corresponding data item is entered into the computing device when a stroke is terminated within a particular region of the terminal data selection menu. In one embodiment, a preview window is displayed to the user via a convenient display means. The preview window displays a data item that is presently selected in the data selection menu. The size and display position of the preview window are fixed, in one embodiment, or user-configurable in other embodiments. The preview window allows use of abbreviated data items in the data selection menus, and permits reduced size data selection menus to be used.

The data selection menus may be fixed, in one embodiment, or have user-configurable sizes, shapes and dimensions. In one embodiment, the data selection menus comprise rectangles having a fixed number of rows and columns. In another embodiment, the data selection menus (both the initial and subsequent data selection menus) are circular, or semi-circular, each having “pie-shaped” data selection regions. In one embodiment, the pie-shaped data selection regions include modifier regions, that, when traversed by an input stroke, cause one or more subsequent data selection menus to be displayed. In this embodiment, when a modifier region is traversed, the circular (or semi-circular) data selection menus appear to rotate (in either a clockwise or counter-clockwise direction, depending upon which modifier region was traversed), resulting in display of additional data items for selection. By continuously traversing the modifier regions, an almost infinite number of data items can be displayed in the subsequent (“rotated”) data selection menus.

### BRIEF DESCRIPTION OF THE DRAWINGS

Embodiments of the present invention will be more readily understood by reference to the following figures, in which like reference numbers and designations indicate like elements.

FIG. 1 is an example of an initial input menu in accordance with the disclosed methods and apparatus.

FIG. 2 illustrates typical display and data entry elements of a PDA that may be used to practice the disclosed methods and apparatus.

FIG. 3 is an example of a particular secondary data selection menu.

FIG. 4 is another example of a particular secondary data selection menu.

FIG. 5 is another example of a particular secondary data selection menu.

FIG. 6 is another example of a particular secondary data selection menu.

FIG. 7 is another example of a particular secondary data selection menu.

FIG. 8 is another example of a particular secondary data selection menu.

FIG. 9 is another example of a particular secondary data selection menu.

FIG. 10 is another example of a particular secondary data selection menu.

FIG. 11 is another example of a particular secondary data selection menu.

FIG. 12 is another example of a particular secondary data selection menu.

FIG. 13 is another example of a particular secondary data selection menu.

FIG. 14 is a variation of the secondary data selection menu of FIG. 10.

FIG. 15 is an exemplary initial data selection menu showing a stroke initiation position.

FIG. 16 shows a secondary data selection menu and a stroke path initiated in FIG. 15.

FIG. 17 illustrates stroke paths across a particular terminal data selection menu that replaced the menu of FIG. 16 due to the stroke path traversing a particular modifier selection region.

FIG. 18 shows stroke paths from FIGS. 15-17 irrespective of changing menu displays.

FIG. 19 is an example of a particular secondary data selection menu.

FIG. 20 illustrates a secondary data selection menu having a layout that is inconsistent with corresponding initial and previous data selection menu layouts.

FIG. 21 shows an exemplary embodiment of a semi-circular data selection menu in accordance with the disclosed methods and apparatus.

FIG. 22 shows an exemplary initial semi-circular data selection menu.

FIG. 23 shows an exemplary secondary semi-circular data selection menu.

FIG. 24 shows an exemplary secondary semi-circular data selection menu.

### DETAILED DESCRIPTION

Appendices A and B, attached hereto, form part of this description.

Basic Data Entry

FIG. 1 illustrates a display area that displays four rows and three columns of data item selection regions in a rectangular matrix arrangement similar to that used for standard telephone keypads. Individual data item selection regions are referenced herein by row number and column letter. For example, as shown in FIG. 1, the top left selection region, which includes text “1” and “del”, is shown in FIG. 1 as located in data item selection region “R1” (shorthand for “Row 1”), and “CA′” (shorthand for Column A′). The convention for identifying data item selection regions is row first, followed by column. For example, the top left data item selection region is identified herein as data item selection region 1A′ of FIG. 1 (i.e., the letter “R”, for row, and letter “C”, for column, is not used when identifying data selection regions). Data item selection region 4B′ (row 4, column B′) of FIG. 1 includes data items (in this case, text) “0” and “spc.” In other embodiments, the data selection menus may take any size or shape, and the number and shape of selection regions within such menus is similarly unlimited. The particular illustrated rectangular matrix menu is convenient, partly due to wide familiarity with telephone keypads, and partly due to space efficiency. Other considerations, or contrary purposes, may well dictate alternative shapes and sizes for such menus.

A display area such as that shown in FIG. 1 may be displayed on a portion of any computer display device. For example, it may be displayed as a soft menu 2 in a touch-sensitive lower portion of a display screen 4 of a Personal Digital Assistant (PDA) 6, as shown in FIG. 2. A pencil-like stylus may accompany the PDA. In such case, entry appears to be directly into such display by means of the stylus. An entry stroke may then be effected by a “down event” of the stylus, followed by a traced path and a termination at an “up event”

Details of entering a “stroke” on the touch-sensitive screen of display area 2 of the PDA 6 follow. A “down event” may be effected by placing the tip of the stylus 8 on the touch-sensitive display 2 with sufficient force to register with the PDA 6. The position that the PDA recognizes for such down event is the initiation position of an input stroke. The stylus may then trace a “path” by moving across or around the display (while remaining in contact with the touch-sensitive screen) to create a sequence of focus points that are recognized by the PDA, which taken together indicate an entire path of the stroke. At a given instant, the path ends at the current focus point that is presently selected by the stylus. The stroke may be terminated by an “up event” in which the stylus is lifted from the touch-sensitive screen of the display area 2 at a stroke termination position recognized by the PDA. The position of the stylus (as recognized by the PDA 6) at the “up event” is the termination point of a “stroke.”

Many alternative techniques, such as a computer mouse or a touchpad, have been developed as feedback devices that may be manipulated by a user to cause perceptible changes to the display area 2 that are analogous to, or give an appearance of, a stroke by the stylus 8 described above. For example, it is common practice to reflect the virtual “location” of a feedback device, such as a mouse, on a display. Various drawing programs, for example, translate manipulation of a mouse so that it appears to have an effect as described above for a stroke by the stylus 8 on the display region 2. Typically, the mouse “virtual position” is indicated by a visual point on the display that moves as the mouse is moved (in contact with a surface). A “stroke” is initiated by depressing a button on the mouse (equivalent to a down event); a “path” is shown that reflects movement of the mouse across a sequence of focus points while the button remains depressed; and releasing the mouse button terminates the stroke at a termination position that is the position of the path, as shown on the display, when the mouse button is released (an “up event”). The feedback device, input device and stylus may be used interchangeably for most purposes herein. Numerous equivalent feedback devices exist, such as fingers on touch sensitive devices, and active stylus that may not need a real surface at all. Moreover, many more such feedback devices will doubtless be developed in the future. An equivalent feedback device will be capable of producing, in response to user manipulation, something equivalent to a “stroke” that registers in a computer device. A “stroke” will include a “down event” initiating the stroke at an initiation position indicated with respect to a display area, a path of the stroke around the display, and a termination of the stroke at a termination position indicated by the path position at the time of an “up event.”

Any such alternative entry technique may be employed, whether previously or later developed, in embodiments of the data input method and system described herein. However, discussion of the data input method and system will proceed with primary reference to a touch-sensitive display area of a PDA, as described above with respect to FIG. 2. The skilled person will have no difficulty modifying the description so as to apply to any alternative entry technique that is capable of registering equivalents to “strokes” as described. Stroke initiations will be described as occurring at a position within a display menu, even though such initiation location may be merely “virtual” or “perceived.” The path of the stroke will be described with respect to a display menu, even though, again, such path may be merely virtual or perceived as the path caused by user manipulation of the feedback device. Similarly, a stroke termination position will be described with respect to the display menu, whether or not the user feedback device manipulation directly or indirectly causes an appearance of such terminating up event.

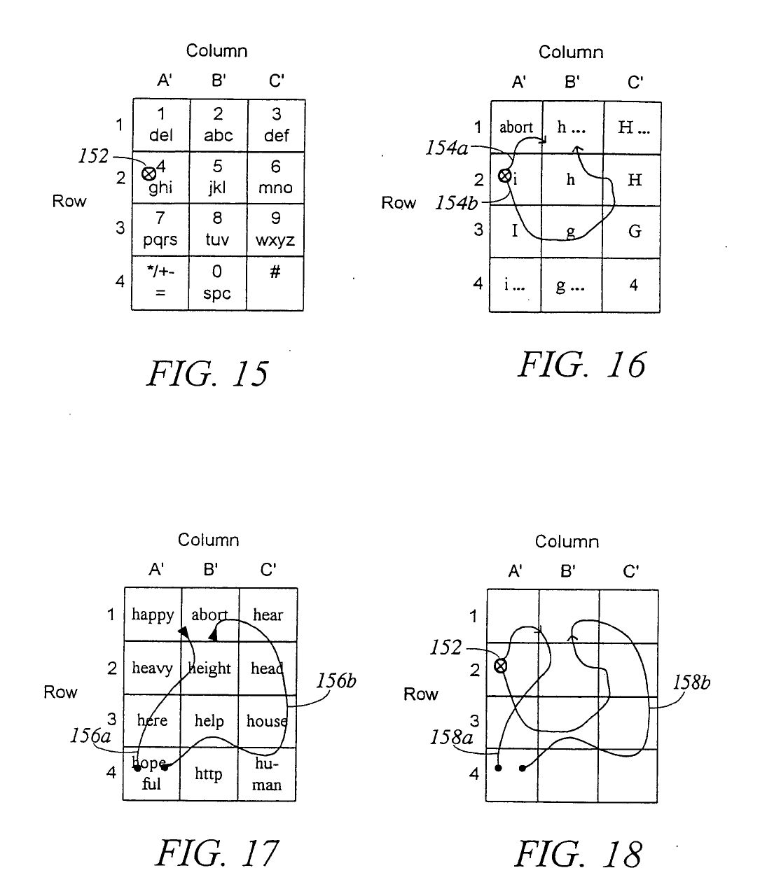

The computer device first displays an “initial input menu” in a display area, which may be a keypad or other input menu such as the initial menu shown in FIG. 1. Each selection region (twelve are shown in the initial input menu of FIG. 1) will typically be marked to indicate data items that may be reached via such selection region. The marking may indicate either specific exemplary data that can be selected by the user, or it may indicate a category of data. In some embodiments, be marking may comprise an abbreviation for data items to be selected by the user. Also, as described in more detail below with reference to FIGS. 15-18, the marking may indicate that the selection region is a “modifier” region that can effect the expansion of selectable data items accessible for user selection.

To enter data into the computer device, the user first initiates a stroke by performing a down event at an initiation position within a particular one of the selection regions of the display area. For present, it will be assumed that the initiation position is within the region 1C′ of a display such as that of FIG. 1.

In one embodiment, substantially immediately upon recognizing such down event, the computer may clear the initial input menu, and replace it with a secondary data selection menu reflecting data items accessible via the region 1C′ of FIG. 1. In one embodiment, as described above, the replacement of the initial input menu with a subsequent menu (and the replacement of an intermediate menu with a further subsequent window) is substantially immediate. However, the disclosed methods and apparatus includes embodiments wherein the replacement of previous menus (either the initial input menu, or subsequent intermediate menus) is not substantially immediate, but rather, is delayed by some convenient time period. In these embodiments, the delay time period can either be selected by the user (i.e., user-configurable), or it can be fixed within the manual user data entry system. As described below in more detail, one purpose of delaying the replacement of previous input menus is to allow the user to see, and appreciate, the effects of traversing a “modifier” region.

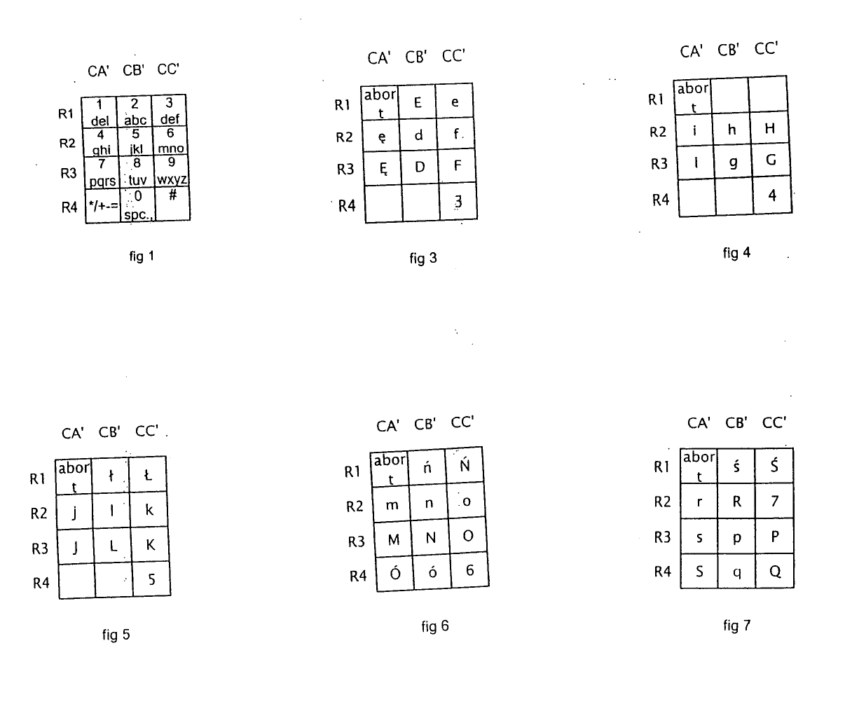

Typically, the secondary menu will occupy a similar shape and/or size area as the initial menu. The secondary menu may have substantially the same layout of selection regions as provided by the initial menu. FIG. 3 shows an example of such replacement menu. As shown in FIG. 3, a variety of specific data items may be indicated to uniquely correspond to specific selection regions. For example, selection region 1C′ of FIG. 3 is indicated to correspond to a lower case letter “e.” Selection region 2C′ corresponds to a lower case letter “f,” region 3B′ corresponds to an upper case letter “D,” and region 4C′ corresponds to a numeral “3.”

Most users would likely expect to find that the data item options that are specified above are, in fact, available for selection in the secondary menu. The indications of selection region 1C′ of FIG. 1, where the user initiated the stroke, would cause many users to expect to find, in the secondary menu, the particular data items that are specified above. Other data items, however, may also be provided, even if not initially expected by many users. Indeed, the particular set of data items that is available for selection via a particular initial menu selection location may be made selectable by the user, as may the particular icons or characters that are provided as an indication of such data items. It may be useful to make such secondary menus consistent (once established by the user), to permit memorization of functional stroke paths. However, such consistency need not preclude an ability to customize the data input selection method or system.

It may be useful to have the path of the stroke initiated in selection region 1C′ of the initial menu (e.g., as shown in FIG. 1) appear to continue in selection region 1C′ of the secondary menu (e.g., as shown in FIG. 3) when the secondary menu replace the initial menu. Indeed, the stroke may be indicated as continuing from a position that is very substantially the same, with respect to the secondary menu outline, as the position at which the stroke was initiated, with respect to the initial menu outline. Many alternatives are possible: as examples, the stroke could be made to begin at a constant position with respect to the secondary menu, such as the center or a particular corner of the menu. Indeed, the secondary menu could be displayed so as to appear to form around the stroke initiation point of the display (such that the stroke continues from the center of the secondary menu). However, by replacing the initial menu with a secondary menu having a similar general shape, and by having the stroke continue from a similarly or identically relative position within such shape, input strokes may be caused by user manipulation of the input device within a small, and potentially constant, area. This may reduce overall movement required for the input feedback device (such as stylus 8 of FIG. 2). Further, it may be useful to extend this concept to further subsequent menus. In these cases, the input stroke may be displayed as continuing from a position that is very substantially the same, with respect to the further subsequent menu outline, as the position at which the stroke was initiated, with respect to the previous menu outline.

The user may then continue the stroke described above. Moving the feedback device (e.g., dragging the stylus 8 of FIG. 2 across the touch-sensitive screen of the PDA 6 of FIG. 2) until the stroke path is within a selection region corresponding to a data item desired for entry, the user may then perform an “up event” to terminate the stroke at a termination position within the corresponding selection region. Thus, continuing the above example with reference to FIG. 3, the stroke may be continued from a location within selection region 1C′ to a termination position within selection region 3B′, where the stroke is terminated by the user executing an up event (such as lifting the stylus 8 from the touch-sensitive entry area 2 of the PDA 6 in FIG. 2). The user would thus have entered an upper case letter “D” into the computer device.

The data item that is selected in the above example is substantially unaffected by the particular path of the stroke that selects such data item. Rather, the data item that is selected is affected primarily, or even exclusively, by the initiation location and the termination location of the stroke. This is typically true even of the physical condition of the particular feedback device at the moment of stroke initiation as compared to the physical condition of the particular feedback device at the moment of stroke termination. Thus, a user may reliably learn to enter particular desired data by manipulating the feedback device along a virtually unlimited number of condition paths from a stroke initiation condition to a stroke termination condition. Such path independence helps eliminate ambiguity and data item errors that may be engendered when a computer interprets path shape to help determine the data that is being selected (as is done by most stroke or character recognition methods). Of the nearly infinite number of possible paths (particularly those that remain upon the general menu area) between given initiation and termination locations, only a small percentage (typically less than 10%) need be “illegal,” or otherwise affect the data selected by such initiation and termination locations.

It may be useful to provide each secondary menu layout consistently as to size, location, relative position of selection regions, and the data corresponding to such regions. Thereby, the user may learn what to expect at each particular selection region, and may become adept at continuing the stroke to the selection region associated with a desired data item without actually focusing upon the provided indication of corresponding data item. Prompt (or immediate) indication of a data item corresponding to each data item selection region may nonetheless be useful to ensure that even a novice user can enter data reasonably quickly, and with certainty as to the data item is being selected.

Ambiguity may be further reduced, together with user eyestrain, by providing an auxiliary preview region (or “preview window”) at a location that is convenient for the user. Such preview region may display, typically in enlarged characters, a description of the data item that will be selected if the user terminates a stroke while the path is at a present focus point. The preview region is particularly helpful in systems where it is difficult to see selected data items due to the physical display area of the selection regions. For example, data items may be covered up or hidden from the user by a stylus or other user input device (e.g., pen, mouse pointer, finger, etc.). In these embodiments, the preview region provides a useful visual feedback mechanism that allows the user to clearly and unambiguously identify the data item presently selected by the data input device.

Referring to FIG. 17, for example, a preview region can be used to display the actual data item presently being selected by the user. For example, if the input stroke traverses path 156a, and falls on the selection region 4A′ (as shown), the preview region displays the presently selected data item “hopeful”. If the user were to select this data item by terminating the input stroke (e.g., by performing an “up event”), the data item displayed in the preview region is selected for entry (i.e., the data item “hopeful” is selected). However, if the input stroke further traverses the input menu of FIG. 17 to the selection region 4C′, the preview region updates its display, and displays the newly selected data item “human”. Again, if the user were to select this data item by terminating the input stroke, the data item currently displayed in the preview region is selected for entry (i.e., the data item “human” is selected).

The preview region can be displayed at any convenient position on the display device, such as, for example, at any convenient position on the display screen 4 (FIG. 2). The preview region may be displayed at a fixed position on the display, or it may be moveable. For example, in one embodiment, the user may indicate where the preview region is displayed. Typically, the preview region will be displayed in a position that is not distracting to the user. For example, on PDA or Palm® hand-held computing device, the preview region might be positioned to the left side of a display for right-handed users, and to the right side of the display for left-handed users. The size and position of the preview window may either be fixed, or it may be user-configurable. In some embodiments, the preview region may be resized, miniaturized, hidden upon command, etc. In addition to providing a useful visual feedback mechanism for the user, the preview region also allows use of abbreviations for the data items in the selection regions. The data selection menu can include identifying markings containing abbreviated or condensed set of information. Because a user can refer to the preview region to determine the exact data item presently being selected, abbreviations and other very condensed markings (such as icons, reduced figures, “thumbnail sketches”, etc.) can be used in the selection regions to represent the data items to be selected. This feature permits use of very small selection regions, and correspondingly small data selection menus.

In order to permit maximum flexibility of paths that may be followed between the initiation and termination positions of a stroke, it may be useful to provide for abortion of a data item entry only by means of selecting a specific “abort” selection region. Such a region is shown in selection region 1A′ of FIG. 3, for example. The abort selection region may be similarly positioned or situated in each terminal menu (i.e., a menu from which a stroke may be properly terminated), which may include secondary menus, intermediate menus, or any other data selection menu from which a data item or abort may be selected.

Particularly when such an abort selection region is provided, excursions of a path beyond the confines of the current menu may be interpreted as if the path continued to remain within the menu confines. Any convenient convention may be used to determine an apparent location of such path within a menu, when the path is directed outside such menu area by the user (i.e., when the feedback device is “out of bounds”). Indeed, alternative “out of bounds” conventions may be made selectable by the user to suit personal preference.

One “out of bounds” convention, for example, may treat the path as remaining at the last focus point before the path exited the menu or display region. When the stylus is manipulated to return into the menu or display region, the path may be considered as having either traversed an outer extreme of the menu region to the reentry focus point, or as having jumped from the exit focus point to the reentry focus point. In another example of an “out of bounds” convention, the focus points of the path that register while the feedback device is “out of bounds” may be interpreted as located on an intersection of the periphery of the menu region with a line between the center of the menu region and the actual recognized “position” caused by the user manipulation of the feedback device. Thus, the path would remain on the outermost edge of the menu region, radially toward the “actual” location recognized for the immediate condition (apparent location) of the feedback device. According to one version of this latter convention, active selection regions may extend to such peripheral paths, while according to another version, such peripheral paths may traverse no active selection regions.

According to yet another “out of bounds” convention, the outer periphery of the menu region, within which the focus points are deemed to be located when the feedback device is “out of bounds,” may be treated functionally as “abort” regions, such that if an “up event” is performed while the focus point of the path is so located, the data input is aborted. Mixtures of these conventions are also possible, as are many other convenient conventions.

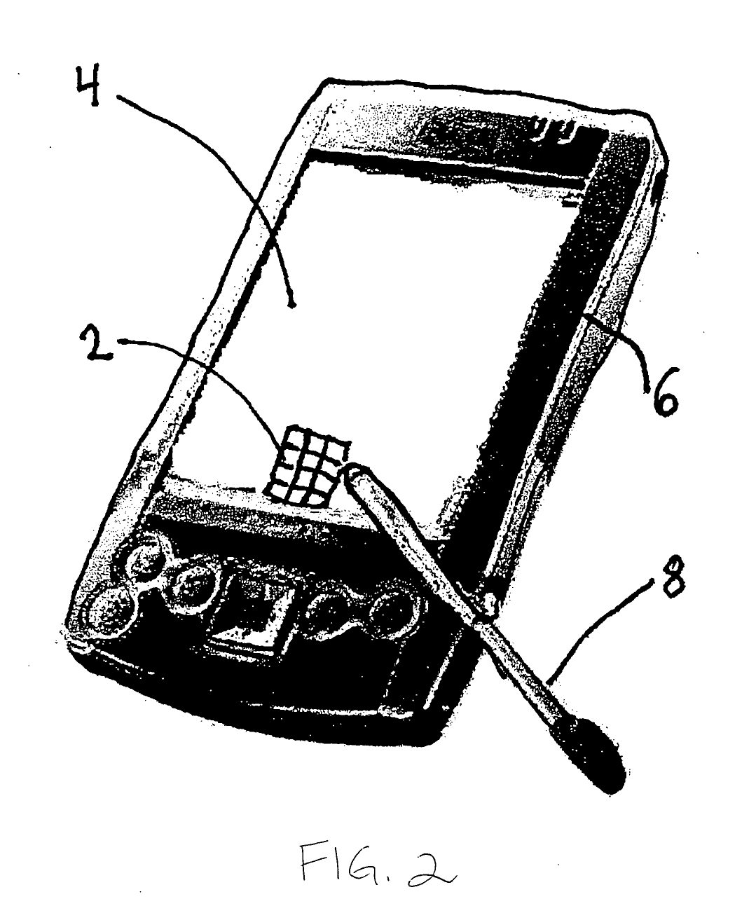

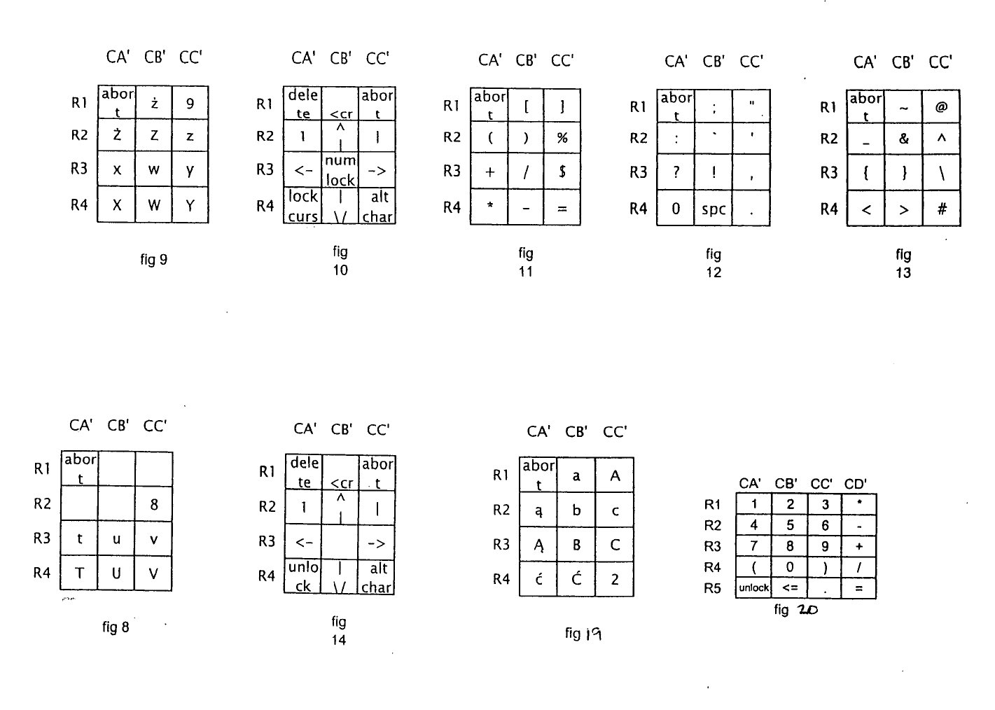

FIGS. 4-13 illustrate exemplary suitable secondary data selection menus that may result from a user initiating a stroke in an initial menu such as that shown in FIG. 1, within the selection regions 2A′, 2B′, 2C′, 3A′, 3B′, 3C′, 1A′, 4A′, 4B′, and 4C′, respectively. More specifically, FIG. 4 shows an exemplary secondary data selection menu that may replace the initial menu of FIG. 1 when the user initiates a stroke within the selection region 2A′ of the initial menu of FIG. 1. Similarly, FIG. 5 shows an exemplary secondary data selection menu that may replace the initial menu of FIG. 1 when the user initiates a stroke within the selection region 2B′ of the initial menu of FIG. 1. FIG. 6 shows an exemplary secondary data selection menu that may replace the initial menu of FIG. 1 when the user initiates a stroke within the selection region 2C′ of the initial menu of FIG. 1. FIG. 7 shows an exemplary secondary data selection menu that may replace the initial menu of FIG. 1 when the user initiates a stroke within the selection region 3A′ of the initial menu of FIG. 1. FIG. 8 shows an exemplary secondary data selection menu that may replace the initial menu of FIG. 1 when the user initiates a stroke within the selection region 3B′ of the initial menu of FIG. 1. FIG. 9 shows an exemplary secondary data selection menu that may replace the initial menu of FIG. 1 when the user initiates a stroke within the selection region 3C′ of the initial menu of FIG. 1. FIG. 10 shows an exemplary secondary data selection menu that may replace the initial menu of FIG. 1 when the user initiates a stroke within the selection region 1A′ of the initial menu of FIG. 1. FIG. 11 shows an exemplary secondary data selection menu that may replace the initial menu of FIG. 1 when the user initiates a stroke within the selection region 4A′ of the initial menu of FIG. 1. FIG. 12 shows an exemplary secondary data selection menu that may replace the initial menu of FIG. 1 when the user initiates a stroke within the selection region 4B′ of the initial menu of FIG. 1. FIG. 13 shows an exemplary secondary data selection menu that may replace the initial menu of FIG. 1 when the user initiates a stroke within the selection region 4C′ of the initial menu of FIG. 1. FIG. 19 is a secondary menu that may result from initiations of a stroke in region 1B′ of an initial menu such as shown in FIG. 1.

Like FIG. 10, FIG. 14 also illustrates a secondary menu due to initiating a stroke in the selection region 1A′ of the initial menu of FIG. 1. However, FIG. 14 appears if the cursor is already “locked”, providing an option to unlock within the data selection regions. Thus, the display of secondary menus may, in some instances, be modified in response to previous actions. However, for input method or system design, the benefits of such toggle-actuation (or other self-modifying data) within menus should be weighed against any reduction in data predictability (due to a particular stroke) that may result.

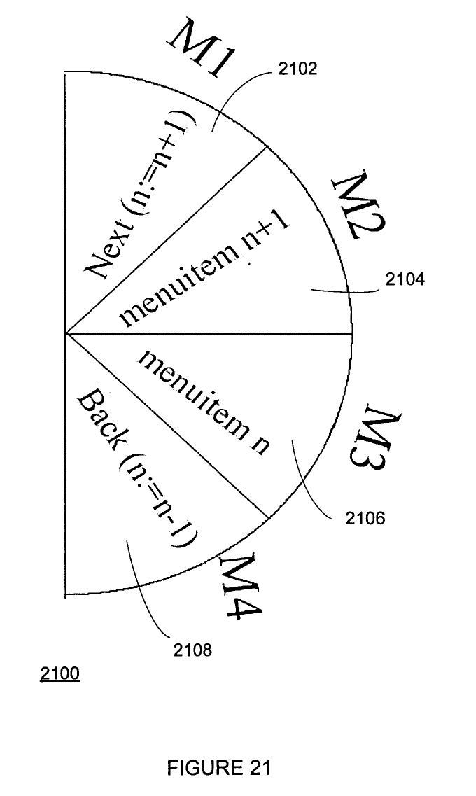

FIG. 20 illustrates a menu that may be employed in lieu of a typical secondary menu. For example, in one embodiment, upon termination of an input stroke into region 3B′ of a secondary data selection menu such as that shown in FIG. 10 (i.e., upon initiation of a “number lock” function), FIG. 20 may appear as a secondary data selection menu. FIG. 20 is an example of a data selection menu that has a different number and/or shape of selection regions from other menus used by the method or system. Advantageously, the present method and system permits use of initial and subsequent data selection windows of differing sizes, number of selection regions, and shapes. The shapes, sizes, and configurations of initial and subsequent data selection menus may be user-configurable, or these parameters may be set by the manual user data entry system. Although rectangular data selection menus are shown in FIGS. 1-20, the data selection menus may be of any convenient shape or size. For example, as described in more detail below with reference to FIGS. 21-24, the data selection menus may be circular or semi-circular.

Modifier Regions Used to Expand a Range of Selectable Data Items

It may be useful to provide for a large number of specifically selectable data items while using a limited size of data entry menu, for example in order to enable selection of specific characters from Chinese or Kanji character sets. “Modifier” regions may be provided that effect an expansion of data items that are accessible for selection from a stroke initiation point within a particular initial menu. Modifier regions are illustrated, for example, in selection regions 1B′ and 1C′ of the data selection menu shown in FIG. 16.

Modifier regions may be generally similar to selection regions, and may have any desired shape or location within a secondary menu. Upon selection, however, a modifier region may cause replacement of a present menu by a further subsequent menu, rather than cause the input of particular selected data to the computer device or system. Such menu replacement may be analogous in many ways to replacement of the initial menu by a secondary menu. However, instead of occurring upon initiation of a stroke by performance of a “down event,” a menu change (or menu replacement, or menu re-display) may be initiated when a path of an input stroke traverses a modifier region, even though an “up event” or stroke termination does not occur. Such modifier region will typically be marked to display an indication of the further data items that may be accessed for selection via such menu change, in order to guide even novice users to data desired for entry.

FIG. 15 is a menu that is nearly identical to the menu illustrated in FIG. 1, and may be viewed together with FIGS. 16, 17 and 18 to consider typical input stroke paths. FIG. 16 is a menu, similar to that shown in FIG. 4, with the addition of modifier regions in selection regions that are unused in FIG. 4. The menu shown in FIG. 16 may, for example, be a secondary menu that replaces an initial menu as shown in FIG. 15 when a user initiates a stroke at a stroke initiation position 152 within selection region 2A′ of the initial menu.

In FIG. 16, the indication of subsequently available data items that correspond to the modifier region 1B′ is “h . . . ” The indication for modifier region 1C′ is “H . . . ” The indication for modifier region 4A′ is “i . . . ,” and for modifier region 4B′ is “g . . . ” Two paths 154 are shown from a first focus point of the stroke path in FIG. 16 up until each path enters modifier region 1B′. A first path, 154a, traverses only a portion of selection region 1A′. A second path, 154b, traverses selection regions 3A′, 3B′, 3C′, 2C′, and 2B′ before reaching modifier region 1B′. These two arbitrary paths will both result in replacement of the menu shown in FIG. 16 by a menu such as that shown in FIG. 17. The two widely different paths illustrate the substantially undefined nature of a path 154.

FIG. 17 shows an exemplary subsequent menu that may be invoked, by traversal of the stroke path into modifier region 1B′, of FIG. 16 to replace the previous menu. The following data items are indicated to correspond to each selection region in this subsequent replacement menu, beginning with region 1C′ and proceeding to region 1B′, and so on to region 4C′: “happy”, “abort”, “hear”, “heavy”, “height”, “head”, “here”, “help”, “house”, “hopeful”, “http”, and “human”. This menu functions as a terminal menu, because particular data items will be selected and entered into the computing device in response to an “up event” in which the user terminates the stroke at a terminal point within a selected selection region. In the example shown, the selected selection region is selection region 4A′. Terminating the stroke in selection region 4A′ will cause data equivalent to the text string “hopeful” to be entered into the computing device. Two paths 156 illustrate alternative examples of paths of the stroke within the menu illustrated in FIG. 17. Path 156a illustrates a continuation of path 154a of FIG. 16, while path 156b illustrates a continuation of path 154b of FIG. 16. The user terminates the paths at the corresponding points marked within the selection region 4A′. Because the paths are substantially undefined, the two exemplary paths are shown to be significantly different.

FIG. 18 illustrates (without indicating the displayed indications of the successive hopeful menus) the two exemplary strokes 158 that each result in entry to the computer system of the text string. The strokes 158a and 158b follow very different paths. They have in common, however, an initiation position within region 2A′, traversal by the path of region 1B′, and ultimate termination in region 4A′.

Because they cause a change in data selection menu during a contiguous input stroke, modifier regions impose some limits upon the variety of alternative paths that may be taken between an initial position and a terminal position, in order to select a particular data item. On one hand, a modifier region may need to be traversed by the path of a stroke to effect entry of certain data items. On the other hand, other data items may require that a stroke path avoid such modifier region. However, as each intermediate menu is replaced as a result of the stroke path traversing a modifier region of a current menu, a new range of possible paths also opens up that increase the overall number of possible paths that may be taken between a particular initiation/termination stroke position pair. Thus, only a small portion of the paths that may be followed between a stroke initiation position and a stroke termination position are generally restricted by the need to traverse, or to avoid traversing, one or more modifier regions. Accordingly, the path of each stroke may remain substantially undefined, even when significant numbers of modifier regions are employed by a particular data entry method or system.

A particular stroke path may only traverse a single modifier region in any particular secondary or intermediate menu, because upon such traversal the present menu changes to a subsequent menu that corresponds to the traversed modifier region. However, a particular menu may include a plurality of modifier regions, and the replacement menus invoked by traversal of any of such modifier regions may themselves have a plurality of further modifier regions. The number of data items selectable from a single initial selection region is the union of all items that are selectable from all terminal menus that are reachable via the secondary menu that replaces such initial menu. If several layers of intermediate menus each have a multiplicity of modifier regions, that number of selectable data items may be very large. Details for calculating the number of data items that may be thus made accessible for selection are provided in addendum to this description.

For example, Appendix A describes exemplary data selection using 2×2 data selection menus, wherein one of the data selection menus includes a modifier region. As noted therein, the number of modifiers (m) may be greater than the number of “keys” n (i.e., selection regions in each menu) on the keyboard. In addition, as noted in Appendix A, the modifiers do not have to appear only on the first level of the virtual keyboard, but may be sub-nested on subsequent menus. Assuming a “keyboard” or input menu having n possible entries, where n equals 4 in this case, and the total number of modifiers (m)=1, the total number of data entries (D) that are accessible for selection by the user is calculated as follows: D=n²+m(n−1).

Appendix A describes an example where the initial input menu contains the data items “1”, “2”, “3”, and “4”. As shown in Appendix A, an initial input stroke in the selection region containing the data item “1” in the initial menu results in the display of the subsequent menu containing the data items “1a”, “1c”, and “1d”, and the modifier “1b”. An initial input stroke in the selection region containing data item “2” results in the display of the subsequent menu containing the data items “2a”, “2b”, “2c” and “2d”. An initial input stroke in the selection region containing the data item “3” in the initial menu results in the display of the subsequent menu containing the data items “3a”, “3b”, “3c” and “3d”. Similarly, an initial input stroke in the selection region containing the data item “4” in the initial menu results in the display of the subsequent menu containing the data items “4a”, “4b”, “4c” and “4d”. As described in Appendix A, one modifier region is used in the example shown, specifically, a modifier region identified with the markings “1b”. This allows a user access to the selection of the following data items: {1a,1c,1d,2a,2b,2c,2d,3a,3b,3c,3d,4a,4b,4c,4d,1bi,1bii,1biii,1biv}. The efficient input paths for selecting the various data items are illustrated in Appendix A, shown as overlaid on an unlabeled representation of the keyboard. As shown therein, the speed and efficiency of the disclosed user data entry method and apparatus allows a user to quickly, easily, and unambiguously, select the entry of a data item from a relatively large number of data items.

Alternative and Additional Data Entry Features

The “h . . . ” modifier region discussed above with respect to FIG. 16 indicates that selectable data items need not be limited to single characters from any character set. The example illustrates use of letter combinations and words as specific selectable data items. However, non-character data may typically need to be entered as well. FIG. 10 illustrates an example of a secondary menu that may replace a menu such as that shown in FIG. 1, such as upon stroke initiation in selection region 1A′. The following describes effects that may follow from stroke termination in each of the twelve selection regions of the secondary menu of FIG. 10, beginning with termination in the region 1A′, proceeding with termination in the region 1B′, and so on to termination in the region 4C′: backwards delete (or forward delete); carriage return; stroke abort; entry of number “1;” scroll up; entry of vertical line; scroll left; modification of the initial menu to enter only numbers like a keypad; scroll right; lock cursor; scroll down; modify all secondary menus to reflect alternate characters. Most of these selectable data, as will be noted, are not text data, but rather enter data that directs the computing device to perform some action. Other data types may also be directly selectable for entry by similar steps.

Referring again to FIG. 2, a manual user data entry system, as described herein, may include a computer device module configured to receive data input by the user, such as the PDA 6. An associated display module may be included that is configured to display various menus, selectable data indications, and selection regions, such as the menu region 2 of the display 4. Such display module need not be attached directly to the computer device that is configured to accept data input. The menu display module may be varied widely. For example, it may be possible to generate a three-dimensional display module, which would likely provide further room for data category and item indications.

Circular and Semi-Circular Data Selection Menus

As described above with reference to the data selection menus illustrated in FIGS. 1-20, the data selection menus may be of any convenient size and shape. The data selection menus may be fixed, in one embodiment, or have user-configurable sizes, shapes and dimensions. In one embodiment, as shown in the data selection menus of FIGS. 1-20, the menus comprise rectangles having a fixed number of rows and columns. In another embodiment, the data selection menus are circular, or semi-circular, each having “pie-shaped” data selection regions. For example, one such exemplary semi-circular data selection window is shown in FIGS. 21-24. As shown in FIG. 21, a semi-circular data selection menu 2100 (shaped as a half circle in the example shown in FIG. 21) contains four “pie-shaped” selection regions, identified in FIG. 21 as regions “M1” 2102, “M2” 2104, “M3” 2106, and “M4” 2108. Two selectable data items, “menuitem n+1” and “menuitem n” appear in selection regions M2 2104 and M3 2106, respectively. The semi-circular data selection menu also contains two modifier regions, indicated by “Next (n:=n+1)”, in selection region Ml 2102, and “Back (n:=n−1)”, in selection region M4 2108.

In accordance with the disclosed user data entry methods and apparatus, and similar to the function and operation of the modifier regions described above, when the input stroke traverses either of the modifier regions (either region M1 2102 or region M4 2108), new selectable data items (and or modifier regions) are displayed to the user. In one embodiment, the circular or semi-circular data selection menu appears to rotate (either in a clockwise or counter-clockwise direction, depending upon the modifier region traversed by the input stroke), revealing new selectable data items (and or modifier regions) in the selection regions.

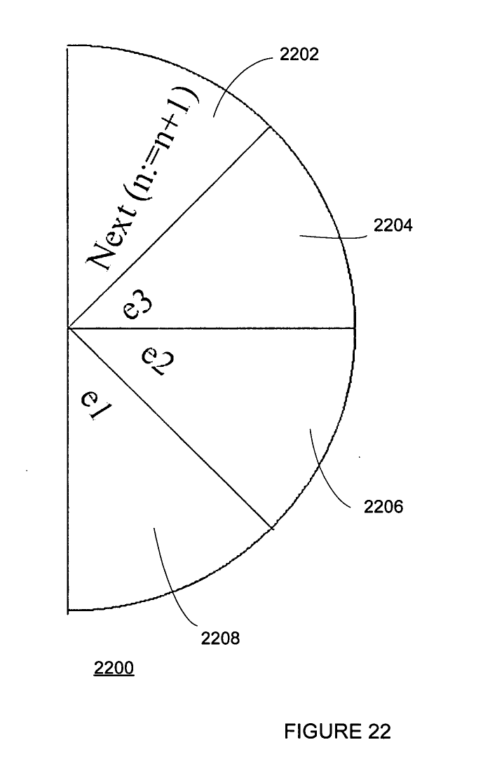

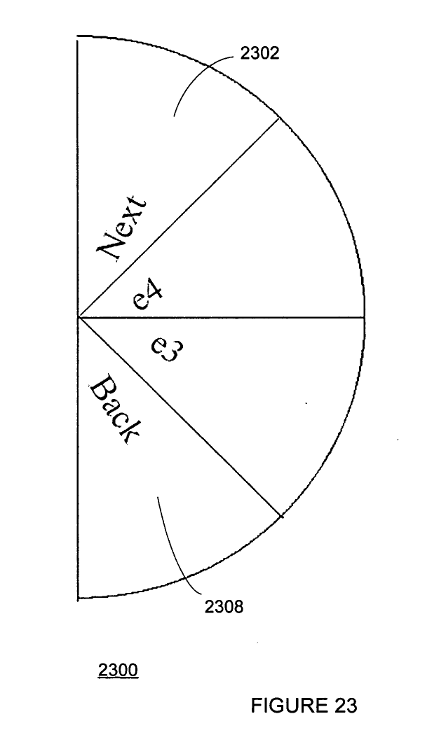

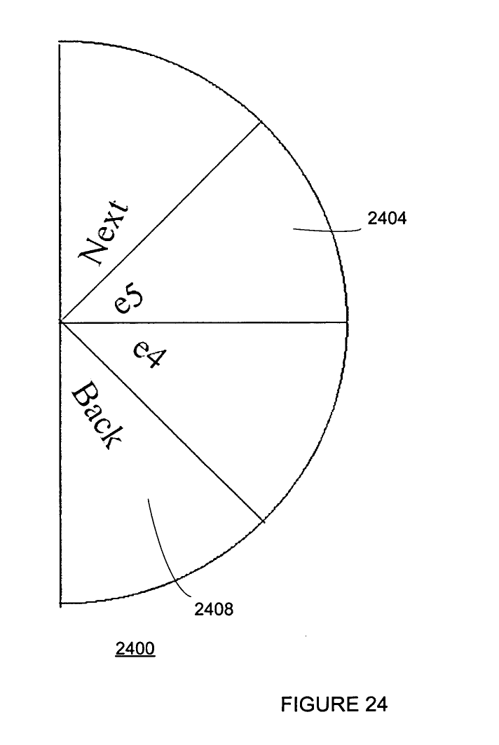

For example, assume there are k selectable data items, represented by the following list of data items: {e1, e2, e3, e4, . . . en−1, en, en+1, . . . ek}. In one embodiment, the initial data selection menu appears as shown in the menu 2200 of FIG. 22. As shown in FIG. 22, in this example, the first selectable data item of this list, namely, item “e1”, appears in selection region 2208 (which is analogous to selection region M4 2108 of FIG. 21). The next two selectable data items, “e2”, and “e3”, appear in selection regions 2206 and 2204, respectively. Finally, the modifier region containing the modifier indicator of “Next (n:=n+1)” appears in region 2202 (in the same location of the modifier region shown in the menu of FIG. 21). It will be appreciated by those skilled in the computer input and display arts that the initial input menu can display any of the items from the available data item list. For example, the initial input menu might comprise that shown in FIG. 23, or FIG. 24, and the disclosed method and apparatus is not limited to the initial menu of FIG. 22. In this example, if the user is not interested in selecting any of the displayed data items, the user causes the input stroke to traverse the modifier region 2202, and the data selection menu 2200 is replaced by the menu 2300 of FIG. 23. In this manner, the data selection menu appears to spin, or rotate, thereby replacing previously displayed selectable data items with new selectable data items.

Using circular or semi-circular data selection menus, the user can select from a potentially infinite number of data items by simply “dialing” into, or out of, a given data item selection. Referring to the menu 2300 of FIG. 23, for example, if the user decides to view previous selectable data items (such as “e1”, “e2” or “e3”, for example), the user causes the input stroke to traverse the modifier region containing the identifier “Back” (the modifier region 2308 in FIG. 23). If, however, the user wishes to view additional selectable data items, the user causes the input stroke to traverse the modifier region containing the identifier “Next” (the modifier region 2302 in FIG. 23). In this example, this causes the data selection menu to appear to “rotate” in a clockwise direction, thereby replacing (redisplaying, or redrawing) the data selection menu 2300 of FIG. 23 with the menu 2400 shown in FIG. 24.

Once the menu 2400 of FIG. 24 is displayed, the user could select a data item for entry by traversing to a data selection region, and terminating the input stroke (via execution of an “up event”, for example). For example, the user could move the data input device to the selection region 2404, release the input device (such as a stylus, for example), and thereby select data item “e5” for input to the computer system. Alternatively, a user might decide that the desired data item was “overshot” or missed, and that previous data items are desired for selection. In this case, the user would move the stylus to modifier region 2408 (selecting the modifier region identified as “Back”). This would cause the data selection menu to appear to “rotate” in a counter-clockwise direction, revealing the previous data items “e4” and “e3”, as shown in the menu 2300 of FIG. 23.

As will be obvious to those skilled in the computer data input and display arts, the disclosed manual user data entry methods and apparatus can use data selection menus of any size, shape, and including any convenient number of selection and modifier regions. Although the data selection menus are shown as half-circles in FIGS. 21-24, the concepts illustrated therein are easily extendable to menus that are completely circular. Also, although only four selection regions are shown in the selection menus of FIGS. 21-24 (for example, in FIG. 21, two modifier regions, and two data item selection regions), the disclosed methods and apparatus contemplate use of data selection menus having more or less selection regions. Also, the ratio of modifier regions and data selection regions is not limited to any specific number, but can be tailored to meet system and user-specific needs. In addition, although the selection regions are shown in all of the exemplary data selection menus as being equally sized and proportionate to each other, there is no need for such a limitation. In other embodiments, the selection regions can be of different sizes as compared to one another.

Conclusion

The foregoing description illustrates exemplary implementations, and novel features, of aspects of a method and apparatus by which a user may enter data into a computing device. The skilled person will understand that various omissions, substitutions, and changes in the form and details of the methods and apparatus illustrated may be made without departing from the scope of the invention. Numerous alternative implementations have been described, but it is impractical to list all embodiments explicitly. As such, it must be understood that each practical combination of apparatus and method alternatives that are set forth above or shown in the attached figures, and each practical combination of equivalents of such apparatus and method alternatives, constitutes a distinct alternative embodiment of the subject apparatus or methods. For example, all initial, secondary, intermediate, subsequent and terminal menus need not have the same form, nor even the same number or relative location of selection regions. Therefore, each input method or system which is otherwise as described, but in which any one, or any combination, of such menus differs from other menus (for example as to shape, size, or number or shape of selection regions), constitutes an alternative embodiment of the data input method and system described herein. Numerous additional embodiments may be otherwise as described herein, but may include a variation in the content of one or more menus, or in the indications used to indicate particular selectable data categories and/or items, or in the feedback element or technique employed. Any other aspect of an embodiment, if not essential to the invention as claimed in a relevant claim, may also be varied to create different embodiments of the manual user data entry and system.

All variations coming within the meaning and range of equivalency of the various claim elements are embraced within the scope of the corresponding claim. Each claim set forth below is intended to encompass any system or method that differs only insubstantially from the literal language of such claim, as long as such system or method is not, in fact, an embodiment of the prior art. To this end, each described element in each claim should be construed as broadly as possible, and moreover should be understood to encompass any equivalent to such element insofar as possible without also encompassing the prior art.

1. A method of inputting data to a computing device that controls an associated display, the method comprising:
a) displaying an initial menu on the display, the menu including a plurality of mutually exclusive initial selection regions each having a corresponding location with respect to the initial menu, and an indication of selectable data corresponding to such region;
b) selecting a particular initial selection region by initiating an input stroke with an input stylus at a location that corresponds to an effective stroke initiation at the location of the particular initial selection region;
c) subsequently replacing the initial menu by a second menu having a plurality of second selection regions arranged to reflect the selectable data corresponding to the particular initial selection region;
d) indicating an effective location of the continuing stroke within the second menu that is substantially the same with respect to the second menu as the location of the particular initial selection region with respect to the initial menu;
e) continuing the initiated input stroke by manipulation of the stylus that corresponds to effective movement of the stroke position along a substantially undefined path within a terminal menu; and
f) terminating the initiated input stroke while the effective stroke position is within a region of the terminal menu that is indicated to correspond to particular data to be entered, whereby to effect entry of the particular entry data into the computing device.

2. The method of claim 1, wherein the second menu comprises the terminal menu.

3. The method of claim 2, further comprising clearing display of a previous menu upon display of a subsequent menu.

4. The method of claim 3, wherein returning to a previous menu requires selection of specific return data in a terminal menu.

5. The method of claim 1, further comprising replacing an intermediate menu by a different subsequent menu upon manipulation of the stylus that causes an effective path of the continuing stroke to traverse an intermediate modifier region disposed at a particular location with respect to the intermediate menu prior to termination of the stroke.

6. The method of claim 5, wherein an effective initial location of the continuing stroke with respect to the subsequent menu is substantially similar to the particular location of the intermediate modifier region with respect to the intermediate menu.

7. The method of claim 6, wherein the subsequent menu includes a further modifier region at a location with respect to the subsequent menu that is distinctly different from the particular location of the intermediate modifier region with respect to the intermediate menu.

8. The method of claim 1, further comprising displaying a preview region that displays data that would be entered into the computing device upon termination of a selection stroke at a present location.

9. The method of claim 8, wherein the size or position of the preview region may be varied by the user.

10. The method of claim 9, wherein the size or position of the preview region is fixed by the computing device.

11. The method of claim 1, further comprising disposing a selectable abort region at a consistent location with respect to a multiplicity of menus, such that data entry to the computing device is aborted when an entry stroke is terminated within any such abort region.

12. The method of claim 1, wherein the plurality of mutually exclusive selection regions of the initial menu are displayed as rectangular areas comprising a substantially m×n rectangular array of selection regions.

13. The method of claim 12, wherein each menu comprises an m×n rectangular array of selection regions.

14. The method of claim 1, wherein the plurality of mutually exclusive selection regions of the initial menu are displayed as pie-shaped selection regions comprising a substantially circular or semi-circular array of selection regions.

15. The method of claim 14, wherein each circular or semicircular menu comprises an array of selection regions.

16. The method of claim 1, further comprising displaying each accessible menu within boundaries of a display device that are substantially the same as boundaries of the initial menu.

17. The method claim 1, further comprising displaying an equal number of similarly arranged selection regions in the second menu as in the initial menu.

18. The method of claim 1, wherein step c) further comprises replacing initial menus with nonvarying secondary menus corresponding to the initial selection region.

19. A system for inputting data to a computing device that controls an associated display, the system comprising:
a) a computer module configured to receive input data;
b) a display module configured to display a sequence of data selection menus, including
i) an initial menu prior to user initiation of a selection stroke, the initial menu including a plurality of initial selection regions having corresponding locations with respect to the initial menu, the initial menu further including an indication of data associated with each selection region, and, responsive to user initiation of a selection stroke,
ii) a secondary menu corresponding to a selection region of the initial menu in which the user initiated the selection stroke, the secondary menu further including a plurality of mutually exclusive secondary selection regions each having a corresponding location with respect to the secondary menu, and indications of selectable data corresponding to such secondary selection regions;
c) an input module configured to respond to manipulation by the user to provide an indication to the computer module of a down event position, an up event position, and a sequence of focus point positions therebetween, each position intended by the user to map to corresponding locations in the display module;
d) wherein the computer module is further configured to
i) direct the display module to indicate a focus point of the stroke, upon replacement of the initial menu, at a position with respect to the secondary menu substantially similar to the position of the initiation location with respect to the initial menu,
ii) to continue to indicate a path of sequential focus points of the stroke that correspond to user manipulations of the feedback module, until the user causes an up event to terminate the stroke, and
iii) to enter data corresponding to a particular selection region of the terminal menu when the user terminates the stroke within such particular selection region of the terminal menu.

20. A method of inputting data to a computing device that controls an associated display, the method comprising:
a) displaying an initial menu on the display, the menu including a plurality of mutually exclusive initial selection regions each having a corresponding location with respect to the initial menu, and an indication of selectable data corresponding to such region;
b) selecting a particular initial selection region by initiating an input stroke with an input device at a location that corresponds to an effective stroke initiation at the location of the particular initial selection region;
c) replacing the initial menu by a second menu having a plurality of second selection regions arranged to reflect the selectable data corresponding to the particular initial selection region;
d) indicating an effective location of the continuing stroke within the second menu;
e) continuing the initiated input stroke by manipulation of the input device that corresponds to effective movement of the stroke position along a substantially undefined path within the secondary menu or a subsequent menu until the path traverses a portion of a modifier selection region, whereupon subsequently replacing of the secondary menu with a further menu that corresponds to the modifier selection region;
f) continuing the initiated input stroke by manipulation of the input device that corresponds to effective movement of the stroke position within a terminal menu; and
g) terminating the initiated input stroke while the effective stroke position is within a region of the terminal menu that is indicated to correspond to particular entry data, whereby to effect entry of the particular entry data into the computing device.
